(19) United States
(12) Patent Application Publication
(10) Pub. No.: US 2012/0132549 A1
(43) Pub. Date: May 31, 2012

(54) Gun Barrel Cleaner

(76) Inventor: George Dewey, Middlebury, CT (US)

(21) Appl. No.: 13/113,547

(22) Filed: May 23, 2011

Related U.S. Application Data
(63) Continuation-in-part of application No. 12/404,730, filed on Mar. 16, 2009, now Pat. No. 7,980,388.

(51) Int. Cl. F41A 29/00; B08B 9/027

(52) U.S. Cl. 206/223; 42/95

(57) ABSTRACT

A gun barrel cleaner comprising: a flexible cable, with a cable diameter; a tip attached to a first end of the flexible cable, the tip having a tip diameter; a connector attached to a second end of the flexible cable, the connector having a connector diameter; a generally spherical member in slideable communication with the flexible cable, the generally spherical member having an outer diameter, a bore, with a bore diameter; where the bore diameter is greater than the cable diameter, is less than the tip diameter, and is less than the connector diameter. A gun barrel cleaning kit comprising: a flexible cable, with a cable diameter; a cleaning tip attached to a first end of the flexible cable, the cleaning tip having a tip diameter, and a cleaning patch receiving slot; a connector attached to a second end of the flexible cable, the connector having a connector diameter; a cleaning brush removeably attached to the connector via a threaded engagement; a generally spherical member in slideable communication with the flexible cable, the generally spherical member having an outer diameter, a bore, with a bore diameter; at least one cleaning patch removeably attachable to the cleaning patch receiving slot; an openable and closeable gun barrel cleaning container configured to hold all of the above listed components; and where the bore diameter is greater than the cable diameter, is less than the tip diameter, and is less than the connector diameter.

### CROSS-REFERENCES

This patent application is a continuation-in-part of patent application Ser. No. 12/404,730, by George Dewey, entitled “Gun Barrel Cleaner”, filed on Mar. 16, 2009, the entire contents of which are fully incorporated by reference herein.

### TECHNICAL FIELD

The present invention relates generally to gun barrel cleaning devices, and more particularly, to a gun barrel cleaner having a flexible cable.

### BACKGROUND

Although a firearm is typically cleaned at home, it sometimes is desirable or absolutely necessary to clean a gun barrel in a field, camp, or elsewhere. For example, if a gun barrel bore becomes clogged with mud or snow while a sportsman is hunting, the hunter must for his own safety remove the obstruction from the barrel bore. Often, when a hunter has such a bore obstruction in his gun it is not convenient or expeditious for him to return home for the sole purpose of cleaning the gun barrel. Similarly if a soldier finds that his gun requires cleaning, he may have to clean his gun out in the field, and such cleaning may be during a life or death situation for the soldier.

In the past, most gun barrel cleaning devices comprised an elongated rigid rod having a cleaning brush secured to one end. Such cleaning devices were obviously cumbersome to transport and difficult to store because of their length and rigidity. Another, more effective, approach to producing a less cumbersome product has been to incorporate a flexible cable, with different accessories that are attached to the cable, such accessories may include a T-shaped handle to allow a user to pull the cable through a gun bore, and or different styles and types of cleaning tips. However, a drawback with the above type of cleaning device, is that the more removable pieces there are, the more likely it is to lose pieces, thus leading to delays in cleaning the firearm and or even the inability to properly clean a firearm.

### SUMMARY

The disclosed invention relates to a gun barrel cleaner comprising: a flexible cable, with a cable diameter; a tip attached to a first end of the flexible cable, the tip having a tip diameter; a connector attached to a second end of the flexible cable, the connector having a connector diameter; a generally spherical member in slideable communication with the flexible cable, the generally spherical member having an outer diameter, a bore, with a bore diameter; where the bore diameter is greater than the cable diameter, is less than the tip diameter, and is less than the connector diameter.

The disclosed invention also relates to a gun barrel cleaning kit comprising: a flexible cable, with a cable diameter; a cleaning tip attached to a first end of the flexible cable, the cleaning tip having a tip diameter, and a cleaning patch receiving slot; a connector attached to a second end of the flexible cable, the connector having a connector diameter; a cleaning brush removeably attached to the connector via a threaded engagement; a generally spherical member in slideable communication with the flexible cable, the generally spherical member having an outer diameter, a bore, with a bore diameter; at least one cleaning patch removeably attachable to the cleaning patch receiving slot; an openable and closeable gun barrel cleaning container configured to hold all of the above listed components; and where the bore diameter is greater than the cable diameter, is less than the tip diameter, and is less than the connector diameter.

### BRIEF DESCRIPTION OF THE DRAWINGS

The present disclosure will be better understood by those skilled in the pertinent art by referencing the accompanying drawings, where like elements are numbered alike in the several figures, in which:

FIG. 1 is a top view of the disclosed gun barrel cleaner;

FIG. 2 is a close-up view of another embodiment of the spherical member;

FIG. 3 is a front view of another embodiment of the spherical member;

FIG. 4 is a close up view of the brush connector;

FIG. 5 is a close up view of the cleaning tip;

FIG. 6 is close up view of the cleaning brush and brush connector;

FIG. 7 is a perspective view of a stuck case attachment;

FIG. 8 is a perspective view of a pick attachment;

FIG. 9 is a perspective view of a scraper;

FIG. 10 shows a side view of a brush connector with a machined area; and

FIG. 11 shows a side view of a brush connector without the machined area.

### DETAILED DESCRIPTION

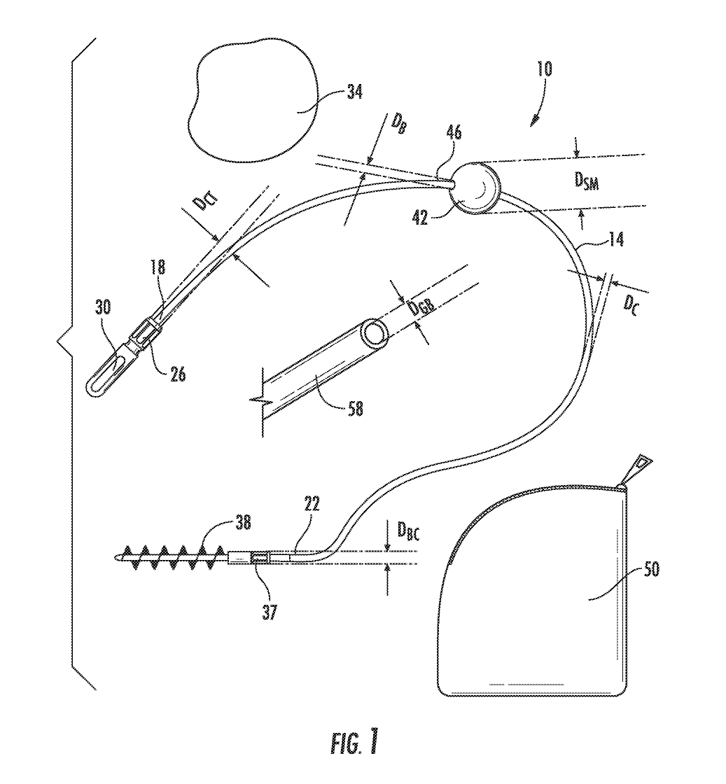

FIG. 1 shows one embodiment of the disclosed gun barrel cleaner 10. The gun barrel cleaner comprises a cable 14, or flexible shaft. In one embodiment the cable may be about 125 lb to 1200 lb test wire cable wrapped in a nylon covering, or a vinyl covering, but may also be wrapped in any other suitably material, or not wrapped at all. Of course other configurations of cable and flexible shafts may be used. The cable 14 has a first end 18 and a second end 22. Attached to the first end 18 is a cleaning tip 26. The cleaning tip 26 comprises a cleaning patch receiving slot 30. A cleaning patch 34 is shown adjacent to the gun barrel cleaner 10. The cleaning patch 34 may be a piece of material suitable for wiping down a gun barrel, such material may include, but is not limited to cotton fabric, nylon fabric, polyester fabric, silk fabric. The cleaning tip 26 may be permanently affixed to the first end 18, or may be removeably attached via threaded engagement with the first end 18. Attached to the second end 22 is a brush connector 37. A cleaning brush 38 may be removeably attachable to the brush connector 37. The cleaning brush 38 is configured to be pulled through a gun barrel and clean/brush the interior surface area of a gun barrel. The cleaning brush 38 may be a wire brush. A spherical member 42 is slideably attached to the cable 14. In one embodiment, the spherical member 42 may have a diameter of about 0.6 inches. The spherical member may be made out of nylon, plastic, wood, metal, fiberglass, rubber or any other suitable material. The spherical member 42 may have a covering to provide better grip to a user, when pulling the cable 14 through a gun barrel. The spherical member 42 comprises a bore 46 that has a diameter D_{B} that is greater than the diameter D_{c} of the cable 14, thus allowing the spherical member 42 to slide up and down the cable 14 until it runs into the cleaning tip 26 or brush connector 37. The cleaning tip 26 and brush connector 37 have diameters D_{CT} and D_{BC} that are greater than the bore 46 diameter D_{B}. In one embodiment, the cable 14 may have a diameter D_{c} of about 0.12 inches, the bore may have a diameter D_{B} of about 0.16 inches, and the cleaning tip D_{CT} 26 and/or brush connector may have a diameter D_{BC} of about 0.2 inches. Of course, these diameters may be changed, and still be within the scope of the disclosed invention, especially when configured to clean larger and smaller barrels. An optional gun barrel cleaner container 50 may be included with the disclosed invention. The container 50, in one embodiment, may be a zippered pouch configured to hold the gun barrel cleaner 10 and cleaning patches 34. In other embodiments, the container 50 may also be configured to hold additional and/or different sized cleaning tips, and cleaning brushes, and other items useful for cleaning firearms. The spherical member 42 has an outer diameter D_{SM}. Also shown in FIG. 1 is a portion of a gun barrel 58. The gun barrel 58 has an inner diameter D_{GB}. The spherical member 42 is sized such that it will not fit inside the gun barrel. Thus D_{SM} is greater than D_{GB}. This allows a user to use the spherical member 42 as a grip or handle, but does not allow the spherical member along with the cable 14 and attachments, such as the brush 38 or cleaning tip 26, to be totally within gun barrel 58. If the spherical member 42 was able to fit into the gun barrel 58, then it is possible that the spherical member 42 along with the cable 14 and attachments may be inadvertently left in the gun barrel where it could be cause harm to a user or damage to the gun when the gun is fired.

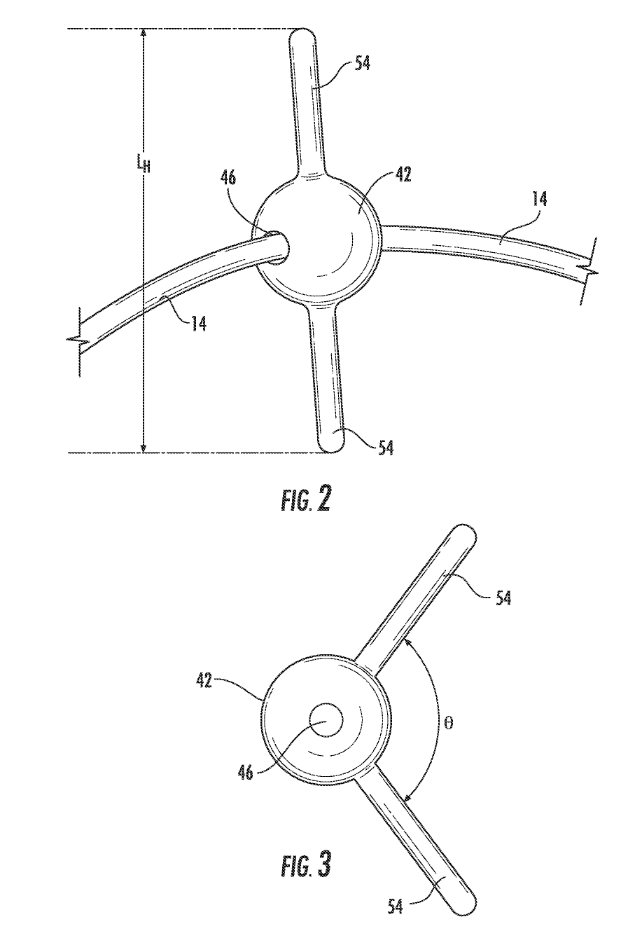

In another embodiment, the spherical member 42 may have two extending members 54 that form a T-handle, as shown in FIG. 2. The total length L_{H} of the two extending members 54 may be about 1.8 inches. Of course other lengths may be used. In addition, instead of both extending members 54 generally lying on the same line, the extending members 54 may be at an angle θ with respect to one another, see FIG. 3.

When using the disclosed invention, one may remove the cleaning brush 38 from the brush connector 37. One then can thread the brush connector 37 end of the cable 14 through a gun barrel. Once the brush connector 37 is threaded through the gun barrel, with a portion of the cable in the gun barrel, one can re-attach the cleaning brush 38 to the brush connector 37. Now, one can pull the cable at or near the cleaning tip 26 end, using the spherical member 42 as a hand hold, thus causing the brush 38 to clean the inside of the gun barrel. Alternatively, one may thread the cleaning tip 26 end of the cable 14 through a gun barrel, then attach a cleaning patch 34 to the cleaning tip 26 (via the slot 30). Once the cleaning patch 34 is attached to the cleaning tip, one pulls at or near the second end 22 of the cable 14, using the spherical member 42 as a hand hold. This causes the cleaning patch 34 to wipe down the interior of the gun barrel.

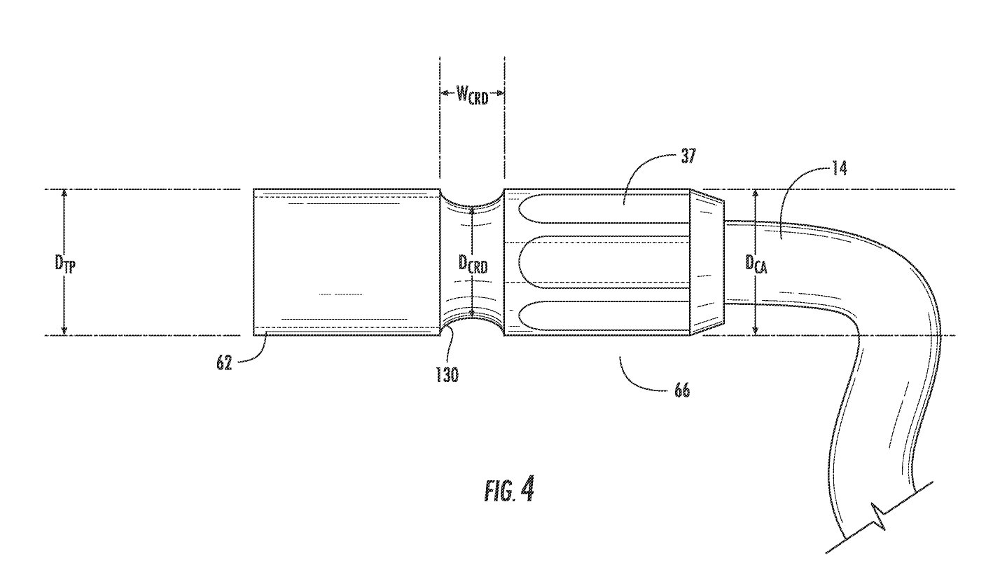

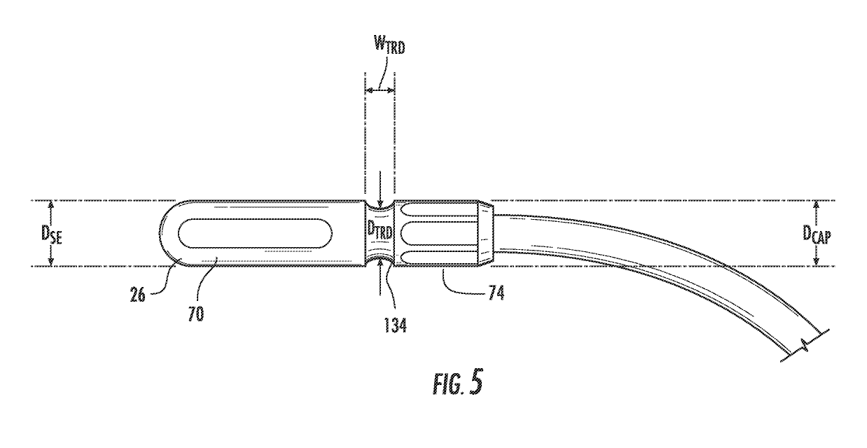

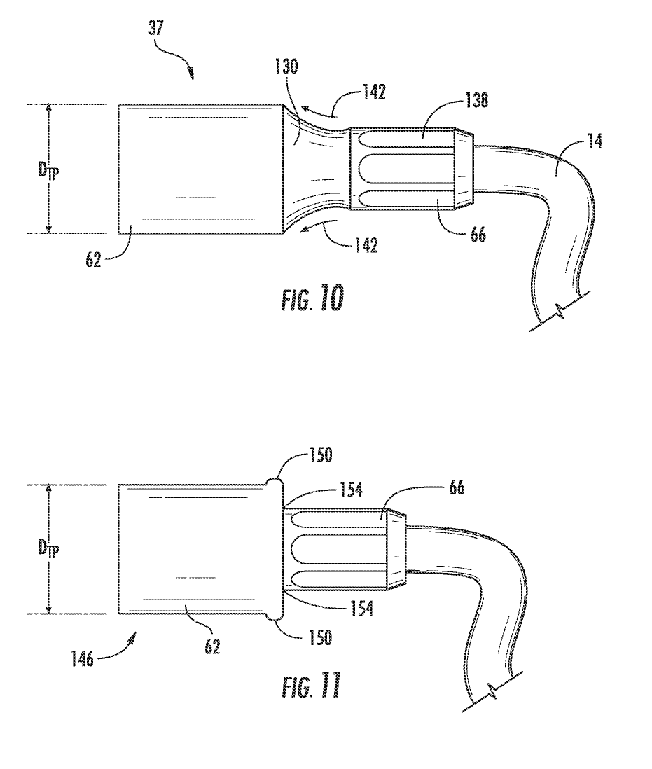

FIG. 4 shows a close up view of a brush connector 37. This attachment, as well as other attachments such as the cleaning tip 26, and other devices or accessories that may screw onto the brush connector 37, may be made out of a variety of materials including but limited to brass, steel, stainless steel, nylon, plastic, fiberglass, and ceramic. However, these attachments, which include the brush connector 37, cleaning tip 26, and other devices or accessories that may screw onto the brush connector 37, may be made out of a metal, or a material that may have a tendency to produce burrs or other irregularities if crimped. In order to solve this problem, the attachments may have a relief are machined on their surfaces. For instance, on the brush connector 37, the threaded portion 62 has an outer diameter D_{TP}. The cable attachment portion 66, has an outer diameter D_{CA}. D_{TP} may be generally about the same as D_{CA}, in one embodiment. In other embodiments, D_{TP} may generally be greater than D_{CA}, and in an other embodiment, D_{TP} may be generally smaller than D_{CA}. During the manufacturing process, the entire brush connector 37 may have a constant outer diameter, such that D_{TP} is the same as D_{CA}. At one step in the manufacturing process, a portion of the outer surface of the brush connector, generally between the threaded portion and the cable attachment portion 66, may be machined down to a Diameter of D_{CRD}. This may be referred to as the machined area 130. In one embodiment, D_{CRD} will be less D_{TP} and D_{CA}. In another embodiment, D_{CRD} will be less either D_{TP} or D_{CA} This reduction in diameter is important because often when a metal part is crimped in order to attach it to another part, such as a cable 14, the crimping process forces metal to flow forward and out from the crimped portion 138 of the brush connector, for instance, see FIG. 10. The arrows 142, in FIG. 10, show how the metal from the crimped portion 138 flows into the machined area 130. This flow of metal eliminates potential burrs in the outer surface of the metal part, such as brush connector 37. If these burrs extend past the diameter D_{TP} they can cause damage to the gun barrel during the cleaning of the gun. In addition this machining step can reduce metal fatigue and separation by eliminating a 90° fatigue area at the base of the crimp. This would reduce the number of replacement cables being needed due to the metal expanding or cracking FIG. 11, shows a metal part, a brush connector 146 for example, but without a machined area 130. As the cable attachment portion 66 is crimped, excess metal is pushed out and away from the crimped portion 138, leading to burrs 150 that can extend past D_{TP}. Also, since the brush connector 146 does not have a machined area 130, there is a generally 90° fatigue area 154, that can lead to metal fatigue and separation of metal at the base of the crimp 154. Therefore, this machining step can reduce metal fatigue and separation, thus leading to fewer replacement cables being needed due to the metal expanding and/or cracking. In one embodiment, D_{TP} may be about 0.2 inches, and D_{CRD} may be about 0.18 inches, and the machined portion may be machined to an about ⅛ inch wide radius. The width of the machined area 130 is W_{CRD} and may be any suitable value, but in one embodiment may range from about 0.08 inches to about 0.14 inches.

Similarly, the cleaning tip also has slot end portion 70 and a cable attachment portion 74. The slot end portion 70 has an outer diameter D_{SE}, and the cable attachment portion 74 has an outer diameter D_{CAP} that may also be generally equal to D_{SE} or less than D_{SE}. The cleaning tip 37, between the cable attachment portion 74 and the slot end portion 70, has been machined down in a similar fashion as described above with respect to the brush connector 37. This machined down area may be referred to as the machined area 134. In one embodiment, D_{SE} may be about 0.2 inches, D_{CAP} may be about 0.2 inches or less, D_{TRD} may be about 0.18 inches, and the machined portion may be machined to an about ⅛ inch wide radius. The width of the machined area 134 is W_{TRD} and may be any suitable value, but in one embodiment may range from about 0.08 inches to about 0.14 inches.

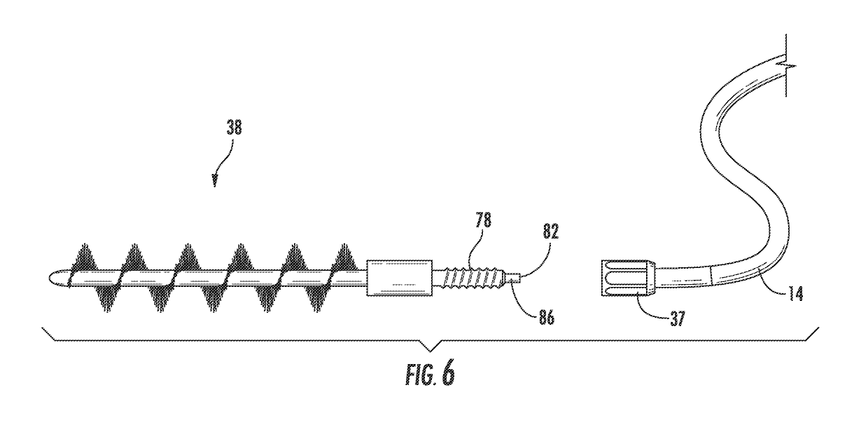

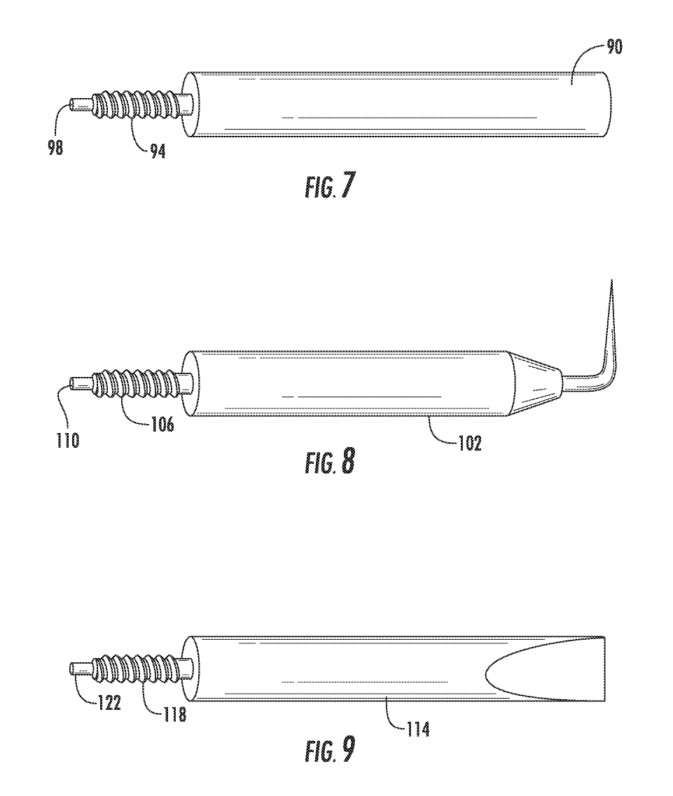

FIG. 6 shows another aspect of the invention. The male threads of all the attachments may have a piloted thread. For instance, the cleaning brush 38 has male threads 78 that threads into female threads located in the brush connector 37. At a proximal end 82 of the cleaning brush, there are no threads, but rather there is a piloted surface 86, that is a generally smooth unthreaded surface, which has a smaller outer diameter than the male threads 78. This piloted surface 86 is beneficial, because if the cleaning brush 38 or other attachments are dropped or mishandled, the piloted surface will probably bear the brunt of any impact or damage, thereby preventing the threads 78 from being damaged. This can be critically important to soldiers who must be able to clean their weapons, and not be hampered by damaged threads on the attachments preventing the threading of the attachments to other components. On a non-piloted thread, the thread itself may absorb any impact from dropping the attachment piece, thus potentially damaging the threads, making the attachment unable to attach to the connector. In addition, the piloted surface 86, acts as a guide, to guide the male thread into the female threaded attachment piece. This enhances a soldier's (or any other user's) ability to clean his or her weapon under adverse conditions, such as poor lighting conditions, and potentially could save lives. The piloted surface may have a length equivalent to about 1 thread to about 4 threads. FIG. 7 shows a stuck case remover attachment 90 with a male thread 94, the male thread 94 having a piloted surface 98. FIG. 8 shows a pick attachment 102 with a male thread 106, the male thread 106 having a piloted surface 110. FIG. 9 shows a scraper attachment 114 with a male thread 118, the male thread 118 having a piloted surface 122.

The disclosed invention has many advantages. One advantage is that there is not the need for a separate “T-handle” to attach to the cable 14, thus there is one less piece that can be lost out in the field. The spherical member 42, may be used as the hand hold to pull the cable 14 through a gun barrel. The spherical member 42, is generally permanently attached to the cable 14, and thus cannot be separated from the cable 14, and thus be lost. The spherical member 42 may optionally come with extending members 54, to provide a better hand hold or grip while pulling the cable 14 through a gun barrel. The machined areas will prevent damages to the interior surfaces of gun barrels. The piloted threads will bear the brunt of any droppings of the attachment pieces, thus preventing damage to the threads. In addition, the piloted areas will act as a guide, to help the user more easily thread the attachments onto the connector piece.

It should be noted that the terms “first”, “second”, and “third”, and the like may be used herein to modify elements performing similar and/or analogous functions. These modifiers do not imply a spatial, sequential, or hierarchical order to the modified elements unless specifically stated.

While the disclosure has been described with reference to several embodiments, it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiments disclosed as the best mode contemplated for carrying out this disclosure, but that the disclosure will include all embodiments falling within the scope of the appended claims.

What is claimed is:

1. A gun barrel cleaner comprising:
a flexible cable, with a cable diameter;
a tip attached to a first end of the flexible cable, the tip having a tip diameter;
a connector attached to a second end of the flexible cable, the connector having a connector diameter;
a generally spherical member in slideable communication with the flexible cable, the generally spherical member having a spherical member outer diameter, and a bore, with a bore diameter;
wherein the bore diameter is greater than the cable diameter, is less than the tip diameter, and is less than the connector diameter; and
wherein the gun barrel cleaner is configured to clean a gun barrel having a gun barrel inner diameter, the gun barrel inner diameter is greater than the cable diameter, the tip diameter, and the connector diameter, and the gun barrel inner diameter is less than the spherical member outer diameter.

2. The gun barrel cleaner of claim 1, wherein the tip is a cleaning tip, the cleaning tip comprising a cleaning patch receiving slot.

3. The gun barrel cleaner of claim 2, wherein the cleaning tip is removeably attached to the first end of the flexible cable via a threaded engagement with the first end of the flexible cable.

4. The gun barrel cleaner of claim 2, wherein the cleaning tip is permanently attached to the first end of the flexible cable.

5. The gun barrel cleaner of claim 1 further comprising:
a cleaning brush removeably attached to the connector via a threaded engagement.

6. The gun barrel cleaner of claim 4, wherein the cleaning brush is a wire brush.

7. The gun barrel cleaner of claim 1, wherein the generally spherical member is made out of a material selected from the group consisting of nylon, plastic, wood, metal, fiberglass, and rubber.

8. The gun barrel cleaner of claim 1, wherein the tip comprises:
a tip cable attachment portion, the tip cable attachment portion having an outer diameter D_{CAP};
a slot end portion, the slot end portion having an outer diameter D_{SE},
a circumferential machined area between the slot end portion and the tip cable attachment portion, the machined area having an outer diameter D_{TRD}, where D_{TRD} is less than D_{SE}, and where D_{TRD} is less than D_{CAP}.
wherein the tip is attached to the cable via a crimp of the tip cable attachment portion onto the cable.

9. The gun barrel cleaner of claim 1, wherein the connector comprises:
a connector cable attachment portion, the cable attachment portion having an outer diameter D_{CA;}
a threaded portion, the threaded portion having an outer diameter D_{TP};
a circumferential machined area between the connector cable attachment portion and the threaded portion, the machined area having an outer diameter D_{CRD}, where D_{CRD} is less than D_{CA} and where D_{CRD} is less than D_{TP}; and
wherein the connector is attached to the cable via a crimp of the connector cable attachment portion onto the cable.

10. The gun barrel cleaner of claim 9, where D_{CA} is generally equal to D_{TP}.

11. The gun barrel cleaner of claim 3, wherein the cleaning tip comprises:
male threads; and
a piloted surface at the proximal end of the cleaning tip, and immediately adjacent to the male threads.

12. The gun barrel cleaner of claim 8, where D_{TRD} is about 0.02 inches less than D_{SE}.

13. The gun barrel cleaner of claim 9, where D_{CRD} is about 0.02 inches less than D_{CA}.

14. The gun barrel cleaner of claim 8, where the circumferential machined area has been machined to an about ⅛ inch wide radius.

15. The gun barrel cleaner of claim 9, where the circumferential machined area has been machined to an about ⅛ inch wide radius.

16. The gun barrel cleaner of claim 9, where the circumferential machined area has a width W_{CRD}, and where W_{CRD} is about 0.08 inches to about 0.14 inches.

17. The gun barrel cleaner of claim 8, where the circumferential machined area has a width W_{TRD}, and where W_{TRD} is about 0.08 inches to about 0.14 inches.

18. The gun barrel cleaner of claim 5, wherein the cleaning brush comprises:
male threads; and
a piloted surface at the proximal end of the cleaning brush, and immediately adjacent to the male threads.

19. A gun barrel cleaning kit comprising:
a flexible cable, with a cable diameter;
a cleaning tip attached to a first end of the flexible cable, the cleaning tip having a tip diameter, and a cleaning patch receiving slot;
a connector attached to a second end of the flexible cable, the connector having a connector diameter;
a cleaning brush removeably attached to the connector via a threaded engagement;
a generally spherical member in slideable communication with the flexible cable, the generally spherical member having a spherical member outer diameter, and a bore, with a bore diameter;
at least one cleaning patch removeably attachable to the cleaning patch receiving slot;
an openable and closeable gun barrel cleaning container configured to hold all of the above listed components; and
wherein the bore diameter is greater than the cable diameter, is less than the tip diameter, and is less than the connector diameter; and
wherein the gun barrel cleaning kit is configured to clean a gun barrel having a gun barrel inner diameter, the gun barrel inner diameter is greater than the cable diameter, the tip diameter, and the connector diameter, and the gun barrel inner diameter is less than the spherical member outer diameter.

20. The gun barrel cleaning kit of claim 19, wherein the cleaning tip comprises:
a tip cable attachment portion, the tip cable attachment portion having an outer diameter D_{CAP};
a slot end portion, the slot end portion having an outer diameter D_{SE},
a circumferential machined area between the slot end portion and the tip cable attachment portion, the machined area having an outer diameter D_{TRD}, where D_{TRD} is less than D_{SE}, and where D_{TRD} is less than D_{CAP}.
wherein the tip is attached to the cable via a crimp of the tip cable attachment portion onto the cable.

21. The gun barrel cleaning kit of claim 19, wherein the connector comprises:
a connector cable attachment portion, the cable attachment portion having an outer diameter D_{CA;}
a threaded portion, the threaded portion having an outer diameter D_{TP};
a circumferential machined area between the connector cable attachment portion and the threaded portion, the machined area having an outer diameter D_{CRD}, where D_{CRD} is less than D_{CA} and where D_{CRD} is less than D_{TP}; and
wherein the connector is attached to the cable via a crimp of the connector cable attachment portion onto the cable.

22. The gun barrel cleaner of claim 20, where D_{TRD} is about 0.02 inches less than D_{SE}.

23. The gun barrel cleaner of claim 21, where D_{CRD} is about 0.02 inches less than D_{CA}.

24. The gun barrel cleaner of claim 20, where the circumferential machined area has been machined to an about ⅛ inch wide radius.

25. The gun barrel cleaner of claim 21, where the circumferential machined area has been machined to an about ⅛ inch wide radius.

26. The gun barrel cleaner of claim 21, where the circumferential machined area has a width W_{CRD}, and where W_{CRD} is about 0.08 inches to about 0.14 inches.

27. The gun barrel cleaner of claim 20, where the circumferential machined area has a width W_{TRD}, and where W_{TRD} is about 0.08 inches to about 0.14 inches.

28. The gun barrel cleaning kit of claim 19, wherein the cleaning brush comprises:
male threads; and
a piloted surface at the proximal end of the cleaning brush, and immediately adjacent to the male threads.

29. The gun barrel cleaning kit of claim 19, wherein the kit further comprises:
a stuck case remover, with a male thread with a piloted surface;
a scraper, with a male thread with a piloted surface; and
a pick, with a male thread with a piloted surface.
